(19) United States
(12) Patent Application Publication
(10) Pub. No.: US 2008/0109987 A1
(43) Pub. Date: May 15, 2008

(54) Hinge buffer device

(76) Inventors: Ken-Ching Chen, Lu-Chu Hsiang (TW); Ting-Tsai Huang, Lu-Chu Hsiang (TW); Chun-Chiang Wang, Lu-Chu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/599,310

(22) Filed: Nov. 15, 2006

(51) Int. Cl. E05F 3/20; E05D 11/06; E05F 5/10

(52) U.S. Cl. 16/68; 16/84

(57) ABSTRACT

A hinge buffer device includes a casing, a slide, a buffer and an adjustment. The casing comprises a first end, a second end, a pair of lugs, a threaded hole, and a sliding trough. The lugs are disposed at two sides of the first end of the casing. The threaded hole is formed at the second end of the casing. The sliding trough is located between the first end and the second end of the casing. The slide comprises a compartment, a pair of sliding sections at respective sides to be engaged with the sliding trough of the casing. The buffer is a cylinder to be mounted in the compartment of the slide. The buffer comprises a piston rod secured to the slide. The adjustment is connected to the slide, and comprises a bolt to be engaged with the threaded hole of the casing.

### BACKGROUND OF THE INVENTION

1. Field of the Invention

The present invention relates to a hinge buffer device, in particular to a device having an adjustment to adjust the position and the buffer force of a buffer.

2. Description of the Prior Art

A conventional furniture hinge comprises a hinge base, a hinge arm and a fixed plate. The hinge arm is pivotally connected to the hinge base in an expandable status. The hinge base is usually secured to a panel while the hinge arm is secured to the fixed plate on a cabinet. The hinge arm is provided with an elastic member to restore the panel back to its original position so as to cover the cabinet. However, the panel mounted with the hinge of the prior art will hit the cabinet directly without any buffer force. Therefore, some of the cabinets are installed with a buffer device to avoid a direct hit of the panel to the cabinet.

Most of the buffer devices comprise a casing and a buffer member. The buffer member is disposed in the casing, and the casing is mounted on the panel or the cabinet. The buffer member is generally made of pneumatic rod or hydraulic rod. Some of the buffer members may be an elastic element which is easily malfunctioned.

The buffer device will engage the panel of the cabinet when it is closed, and the elastic element of the extension arm has a weak resistance to slow the closing movement of the panel.

However, after a period of time, the hardware will fatigue and require making an adjustment. The adjustment may also require a realignment. As disclosed in U.S. Pat. No. 6,591,454 B2, the buffer member can not be realigned. Some of the buffer members require to adjust at least two bolts to do the alignment, which is inconvenient.

### SUMMARY OF THE INVENTION

It is the primary objective of the present invention to provide a hinge buffer device, which has an adjustment to adjust the position of a buffer and to change the buffer's reaction.

The present invention comprises a casing, a slide, a buffer and an adjustment. The casing comprises a first end, a second end, a pair of lugs disposed at two sides of the first end of the casing, a threaded hole formed at the second end of the casing, and a sliding trough located between the first end and the second end. The slide comprises a compartment and a pair of sliding sections at respective sides thereof to be meshed with the sliding trough of the casing. The buffer is a cylinder to be mounted in the compartment of the slide. A piston rod of the cylinder is secured to the slide. The adjustment comprises a bolt to be connected with the threaded hole of the casing. By screwing the bolt, the slide is adjustable with respect on the casing so as to adjust the position of the buffer.

The slide has a T-shaped trough and the adjustment has a stud corresponding to the T-shaped trough for engagement purpose. Each of the lugs of the casing has a through hole. The bolt of the adjustment is provided with a knob.

It is another objective of the present invention to provide a hinge buffer device, which is simple in structure and has a low production cost.

It is a further objective of the present invention to provide a hinge buffer device, which is easy to operate, simply adjusting the knob of the bolt without the necessary of any tool.

It is still a further objective of the present invention to provide a hinge buffer device, which can be mounted on a hinge base directly instead of a panel, so that when the panel is closed it can only reach to the extension arm of the hinge.

### BRIEF DESCRIPTION OF THE DRAWINGS

FIG. 1 is an exploded view of a first embodiment of the present invention applied to a hinge;

FIG. 2 is a perspective view of the first embodiment of the present invention applied to the hinge mounted on a panel;

FIG. 3 is a perspective view of a slide and an adjustment of the first embodiment of the present invention;

FIG. 4 is a cross-sectional view showing the co-relationship between the slide and the adjustment;

FIG. 5 is a top view of a cabinet panel incorporated with the present invention showing that the panel is slowed down when the hinge is bent at a small angle with respect to the casing;

FIG. 6 is a view similar to FIG. 5 showing that the panel is slowed down when the hinge is bent at a larger angle with respect to the casing;

FIG. 7 is a perspective view showing that a cabinet is installed with the present invention in a closed position;

FIG. 8 is a perspective view of a second embodiment of the present invention without the adjustment; and

FIG. 9 is a perspective view of the second embodiment of the present invention showing that the slide is formed integrally with the casing.

### DETAILED DESCRIPTION OF THE PREFERRED EMBODIMENTS

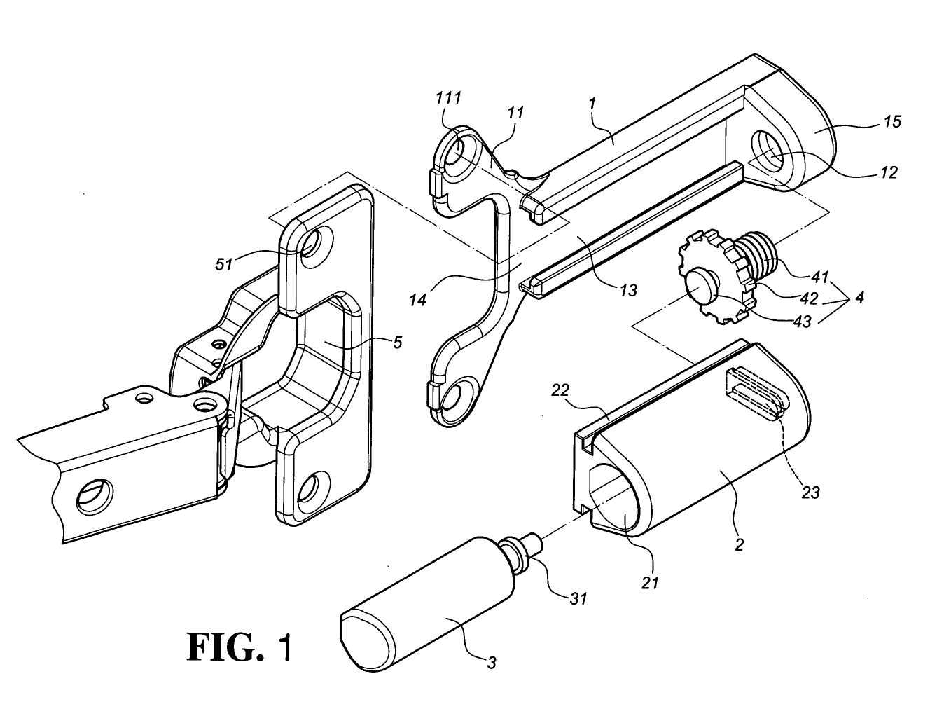

As shown in FIG. 1, a first preferred embodiment of the present invention comprises a casing 1, a slide 2, a buffer 3 and an adjustment 4.

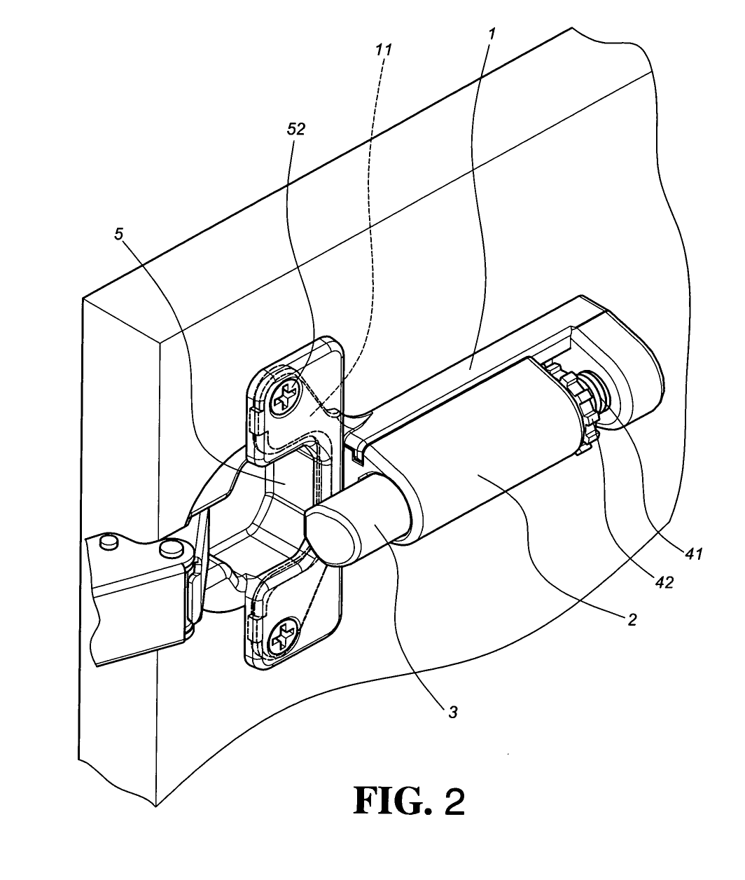

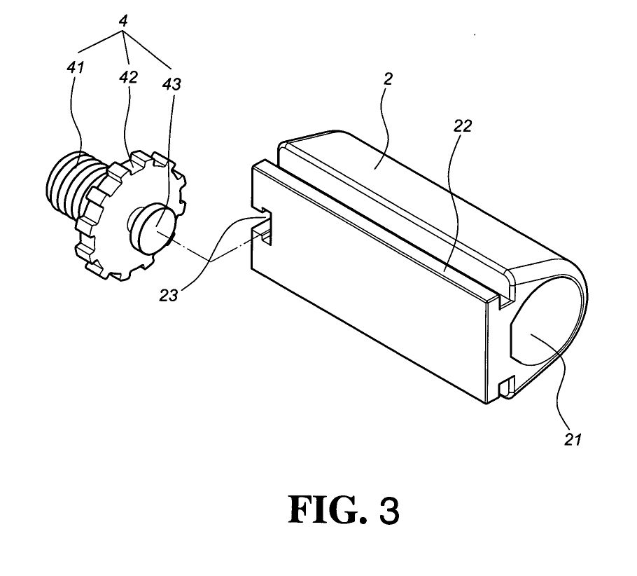

The casing 1 comprises a pair of lugs 11, a threaded hole 12 and a sliding trough 13. The lugs 11 are formed at respective sides of a first end 14 of the casing 1. Each of the lugs 11 has a through hole 111 corresponding to a threaded hole 51 of a hinge base 5, as shown in FIG. 2, for mounting purpose by means of fasteners 52 to secure the casing 1 and the casing base 5 onto a cabinet panel. The threaded hole 12 is formed at a second end 15 of the casing 1. The axis of the threaded hole 12 is parallel with the sliding trough 13. The sliding trough 13 is located between the first end 14 and the second end 15.

The slide 2 has a compartment 21 therein and a pair of sliding sections 22 at respective sides thereof corresponding to the sliding trough 13 of the casing 1. A T-shaped trough 23 is formed at one end of the slide 2.

The buffer 3 is a cylinder, and comprises a piston rod 31 at one end thereof. The cylinder is mounted in the compartment 21 of the slide 2 while the piston rod 31 is secured to the slide 2. In this embodiment, the cylinder is an air pressure cylinder. The buffer 3 may be either a hydraulic style or a mechanical style.

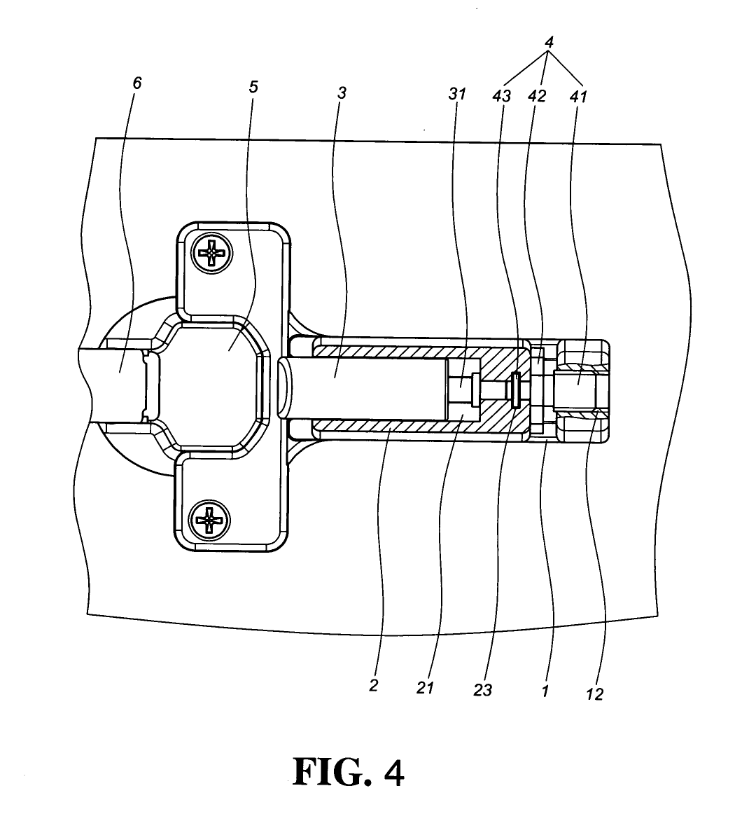

The adjustment 4 comprises a bolt 41 and a knob 42. The bolt 41 corresponds to the threaded hole 12 of the casing 1. The adjustment 4 as shown in FIG. 4, comprises a stud 43 corresponding to the T-shaped trough 23 of the slide 2. The stud 43 has a cross sectional shape that resembles an English letter T.

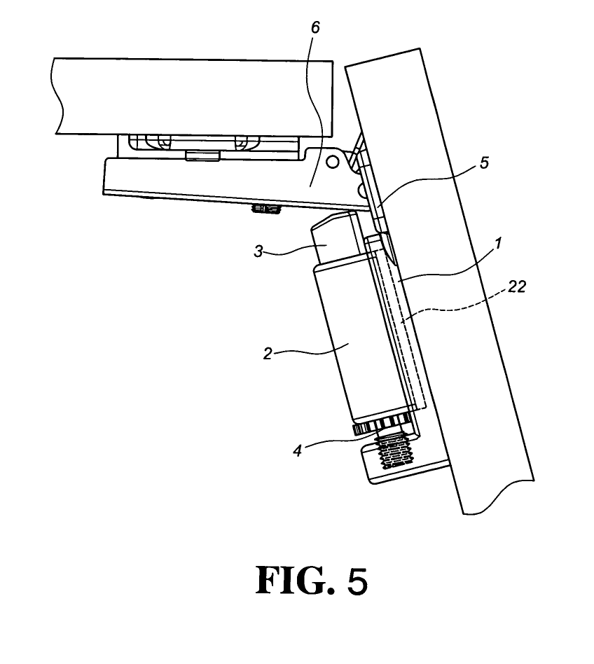

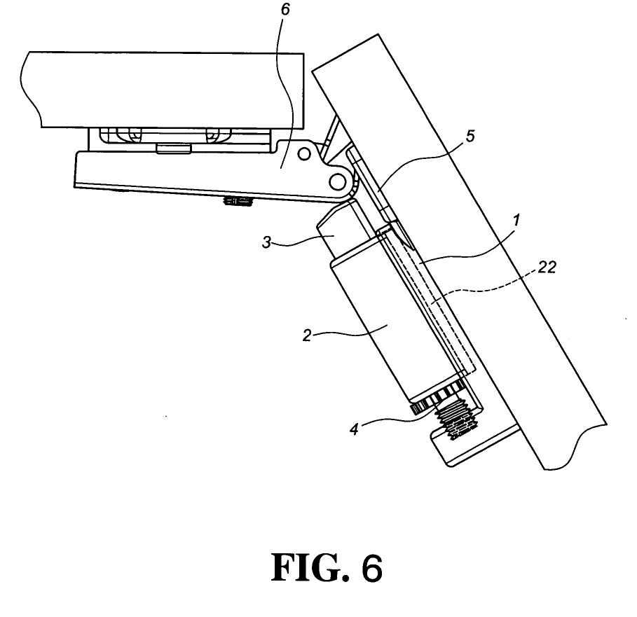

The knob 42 of the adjustment 4 is to screw the bolt 41 in and out of the threaded hole 12 of the casing 1, which links the stud 43 to move the slide 2, as shown FIGS. 5 and 6. That will adjust the reaction of the buffer 3. In other words, when the panel reaches to an appropriate position, a hinge extension arm 6 will engage with the buffer 3. If the buffer 3 is an elastic mechanic type, the pressure from the hinge extension arm 6 will cause the buffer 3 to retreat backward to a distance. The distance is able to be adjusted as required to provide the buffer effect.

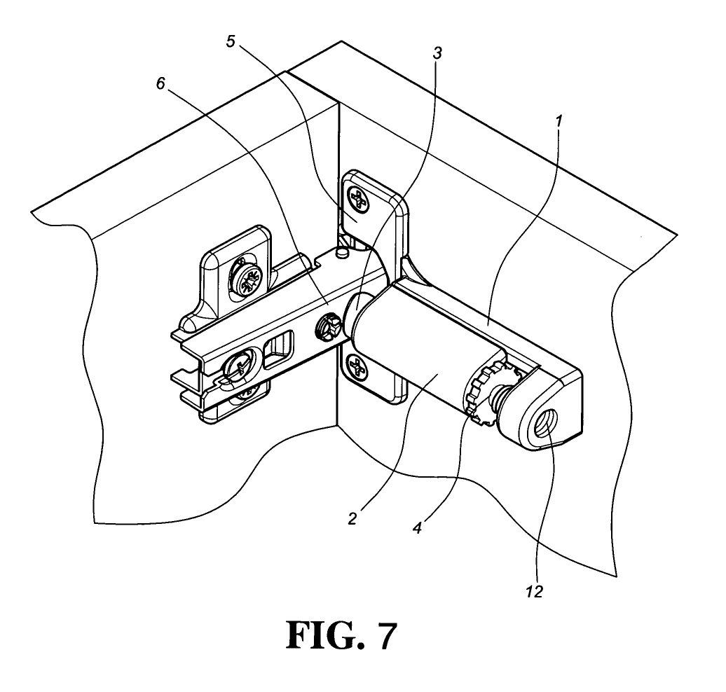

To practice, as shown in FIG. 7, when closing the cabinet panel, the buffer 3 will slow down the panel before it reaches to the hinge extension arm 6 until it final stop.

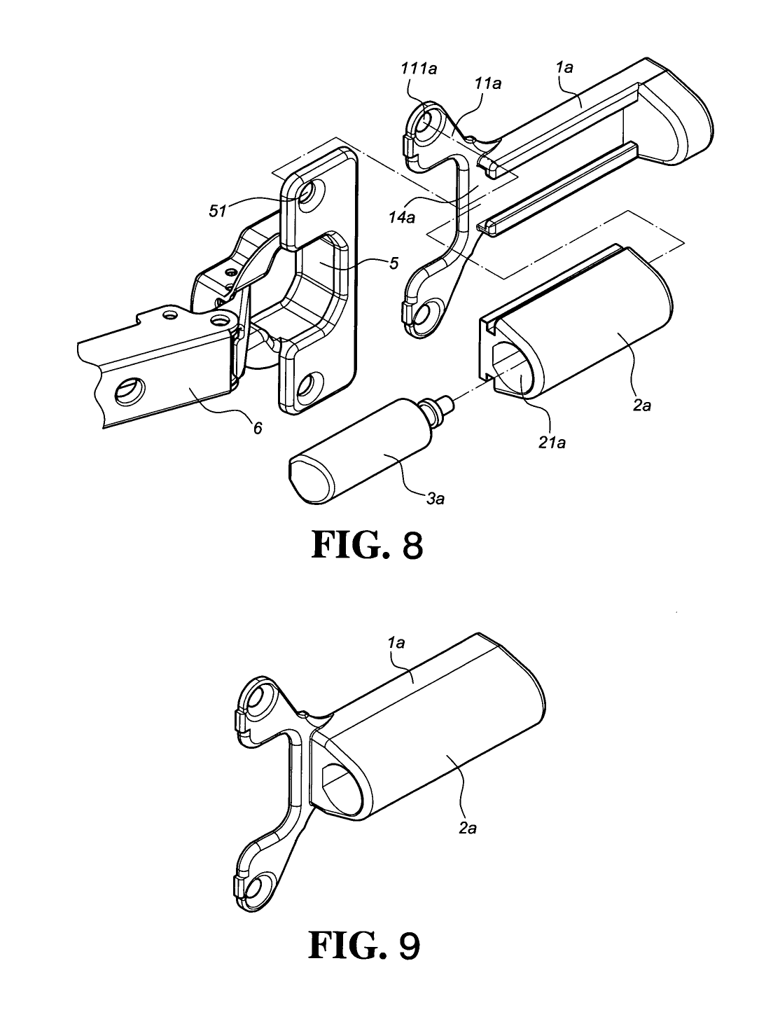

A second embodiment of the present invention, as shown in FIG. 8, displays a hinge buffer device without the adjustment, and comprises a casing 1a, a slide 2a and a buffer 3a. The casing 1a comprises a pair of lugs 11a at respective ends of a first end 14a thereof. Each lug 11a has a through hole 111a corresponding to the threaded hole 51 of the hinge base 5. The slide 2a has a compartment 21a and is secured to the casing 1a. The buffer 3a secured to the slide 2a protrudes from the slide 2a towards the lugs 11a and engages with the hinge extension arm 6. As shown in FIG. 9, the slide 2a may be formed integrally with the casing 1a.

What is claimed is:

1. A hinge buffer device comprising:
a casing comprising a first end, a second end, a pair of lugs, a threaded hole and a sliding trough, said lugs being formed at respective sides of said first end, said threaded hole being formed at said second end, said threaded hole's axis being parallel with said sliding trough, said sliding trough being located between said first end and said second end;
a slide comprising a compartment and a pair of sliding sections at respective sides thereof corresponding to said sliding trough of said casing;
a buffer being a cylinder having a piston rod secured to said slide, said cylinder being disposed in said compartment of said slide; and
an adjustment comprising a bolt screwed to said threaded hole of said casing and being connected to said slide, by rotating said bolt to link said slide to move simultaneously.

2. The hinge buffer device, as recited in claim 1, wherein each of said lugs has a through hole corresponding to a threaded hole of a hinge base.

3. The hinge buffer device, as recited in claim 1, wherein said slide comprises a trough, and said adjustment comprises a stud corresponding to said trough of said slide.

4. The hinge buffer device, as recited in claim 3, wherein said trough has a cross sectional shape that resembles an English letter T, and said stud has a cross sectional shape that resembles an English letter T.

5. The hinge buffer device, as recited in claim 1, wherein said bolt of said adjustment is provided with a knob.

6. A hinge buffer device comprising:
a casing comprising a first end, a pair of lugs being formed at respective sides of said first end, each said lug having a through hole corresponding to a threaded hole of a hinge base;
a slide comprising a compartment and being connected to said casing; and
a buffer being a cylinder having a piston rod, said piston rod being secured to said slide, said cylinder being disposed in said compartment of said slide and extending outwardly toward said lugs with a protruding portion of said cylinder engaging with a hinge extension arm.

7. The hinge buffer device, as recited in claim 6, wherein said slide is formed integrally with said casing.
